(19) United States
(12) Patent Application Publication
(10) Pub. No.: US 2026/0027506 A1
(43) Pub. Date: Jan. 29, 2026

(54) Process for Removing Particulate Matter from a Waste Gas Stream

(71) Applicant: Rubber Nano Products (Proprietary) Limited, Gqeberha (ZA)

(72) Inventor: Robert Michael Bosch, Gqeberha (ZA)

(21) Appl. No.: 18/998,203

(22) PCT Filed: Jul. 26, 2023
(86) PCT No.: PCT/IB2023/057573

§ 371 Date: Jan. 24, 2025

(30) Foreign Application Priority Data
Jul. 27, 2022 (ZA) 2022/08354

(51) Int. Cl. B01D 47/10

(52) U.S. Cl. CPC B01D 47/10; B01D 2258/0291

(57) ABSTRACT

A process for the removal of particulate matter from a waste gas stream includes treating the waste gas stream with a scrubbing liquid including a treatment composition. The treatment composition is a water soluble polymer based solution including a cationic silicate component. The invention further relates to a scrubbing liquid suitable for use in a wet scrubbing method, including the treatment composition in water at a concentration of about 0.01 to about 10% w/w.

### CROSS-REFERENCE TO RELATED APPLICATIONS

This application is the United States national phase of International Patent Application No. PCT/IB2023/057573 filed Jul. 26, 2023, and claims priority to South African Patent Application No. 2022/08354 filed Jul. 27, 2022, the disclosures of which are hereby incorporated by reference in their entireties.

### BACKGROUND OF THE INVENTION

### Field of the Invention

This invention relates to a process for removing particulate matter from a waste gas stream using a scrubbing liquid comprising a treatment composition including a non-aqueous water soluble polymer based composition comprising a cationic silicate component. In particular, but not exclusively, the invention provides for a process for removing PM10, PM4, PM2.5, and PM1 particulate matter from a waste gas stream.

### Description of Related Art

The presence of high levels of particulate matter, in particular fine particulate matter, in the atmosphere is associated with a high number of illnesses and even premature deaths annually. Additionally, these pollutants have significant impact on sensitive ecosystems.

Liquid or solid particles can be removed from a waste gas stream by transferring them to a liquid. The liquid most commonly used is water. Further, it is well known that a wet scrubber's particulate collection efficiency is directly related to the amount of energy expended in contacting the waste gas stream with the scrubbing liquid. This accordingly has a direct impact on the operating cost of the particular scrubbing system.

While many traditional wet scrubber systems are common in industry, there is a need for improvements in the engagement efficiency of the scrubbing liquid droplets with the particles to be removed from the gas stream.

In particular, there is a need for an improvement in these systems as it relates to the removal of fine particulate matter which is hazardous to human health. There is also a need for improvement in the efficiency of the scrubbing liquid, thereby to reduce the volume of scrubbing liquid used whilst maintaining the same, or improved, particulate matter removal efficiency.

### SUMMARY OF THE INVENTION

According to a first aspect to the present invention there is provided a process for the removal of particulate matter from a gas stream, the process comprising the steps of:
a) providing a waste gas stream containing particulate matter, and
b) treating the waste gas stream with a scrubbing liquid to produce a treated gas stream having a particulate matter concentration that is less than the particulate matter concentration of the waste gas stream,
   wherein the scrubbing liquid comprises a treatment composition,
   wherein the treatment composition is a polymer based solution comprising a cationic silicate component, and wherein the polymer is a water soluble polymer.

In one embodiment, the scrubbing liquid is a solution of the treatment composition in water.

In one embodiment, the scrubbing liquid comprises about 0.01 to about 10% w/w of the treatment composition.

In another embodiment, the scrubbing liquid comprises about 90 to about 100% w/w of the treatment composition.

In a preferred embodiment, the process is a wet scrubbing process, and wherein the wet scrubber device is a device selected from a spray tower, a cyclonic spray tower, a dynamic scrubber, a tray tower, a venturi scrubber, and an orifice scrubber.

In one embodiment, the waste gas stream has a PM10 concentration of about 5% to about 30% w/w based on the total particulate matter content in the waste gas stream.

In a preferred embodiment, the removal efficiency for the PM10 fraction is improved by 10% or more compared to removal efficiency for a process utilising the same process parameters but excluding the treatment composition from the scrubbing liquid.

In a preferred embodiment, the removal efficiency for the PM10 fraction is improved by 15% or more, 20% or more, or 30% or more compared to removal efficiency for a process utilising the same process parameters but excluding the treatment composition from the scrubbing liquid.

In one embodiment, the waste gas stream has a PM4 concentration of about 5% to about 30% w/w based on the total particulate matter content in the waste gas stream.

In a preferred embodiment, the removal efficiency for the PM4 fraction is improved by 10% or more compared to removal efficiency for a process utilising the same process parameters but excluding the treatment composition from the scrubbing liquid.

In a preferred embodiment, the removal efficiency for the PM4 fraction is improved by 15% or more, 20% or more, or 30% or more compared to removal efficiency for a process utilising the same process parameters but excluding the treatment composition from the scrubbing liquid.

The waste gas stream may originate from a mining operation, a grinding operation, general dust control, or an incineration or boiling operation.

In one embodiment, the scrubbing liquid is directed counter to the waste gas stream, in the same direction as the waste gas stream, or perpendicular to the waste gas stream.

In one embodiment, the treatment composition further comprises a cationic additive component.

In one embodiment, the cationic additive component is a salt of a compound selected from a group of compound classes including thiazoles, dithiocarbamates, dithiophosphates, sulfenamides, thiuram sulfides, xanthates, guanidines, and aldehyde amines.

In one embodiment, the cationic additive component is a salt of a compound selected from a group of compound classes including thiazoles, dithiocarbamates, dithiophosphates, thiuram sulphides, or combinations thereof.

In a preferred embodiment, the cationic additive component is a salt of 2-mercaptobezothiazole (MBT), zinc dibenzyldithiocarbamate (ZBEC), zinc dialkyldithiophosphate (ZBOP), tetrabenzyl thiuramdisulfide (TBzTD), Di-isopropyl xanthogen disulphide (DIXD) or polysulfide (AS100), or combinations thereof.

In one embodiment, the salt is a sodium or potassium salt.

In one embodiment, the cation of the cationic silicate component is a sodium or potassium cation.

In a preferred embodiment, the water soluble polymer is an ethylene oxide polymer or polyvinyl alcohol polymer.

In a particularly preferred embodiment, the water soluble polymer is polyethylene glycol.

In one embodiment, the water soluble polymer has a molecular weight of between 300 g/mol and 10,000,000 g/mol, preferably between 500 and 20,000 g/mol, more preferably between about 1,000 and 10,000 g/mol.

According to another aspect to the present invention there is provided for the use of a treatment composition to improve the particulate matter removal efficiency of a wet scrubbing process, wherein the treatment composition comprises a polymer based solution of a cationic silicate component, and wherein the polymer is a water soluble polymer.

According to another aspect to the present invention there is provided for a scrubbing liquid which is suitable for use in a wet scrubbing method, wherein the scrubbing liquid is a solution of a treatment composition in water at a concentration of about 0.01 to about 10% w/w of the scrubbing liquid, and wherein the treatment composition comprises a polymer based solution of a cationic silicate component, and wherein the polymer is a water soluble polymer.

### BRIEF DESCRIPTION OF THE DRAWINGS

The terms Fig., Figs., Figure, and Figures are used interchangeably to refer to the corresponding figures in the drawings.

The invention will now be described in more detail with reference to the following non-limiting embodiments and figures in which:

FIG. 1 shows a wet scrubber test configuration as used in the examples which follow;

FIG. 2 graph illustrating the particle diameter cumulative distribution function for the graded coal used in experiment 2 and 3;

FIG. 3 shows the coal CDF for the region particular to the sensor used in the experiments; and

FIG. 4 shows the CDF averages for water and coal in the ZNeck, ZUp, and ZDown regions;

FIG. 5 shows the CDF averages for water and coal in the ZNeck, ZUp, and ZDown regions relative to 10 μm;

FIG. 6 shows the CDF averages for water doped with PEGSIL and coal in the ZNeck, ZUp, and ZDown regions;

FIG. 7 shows the CDF averages for water doped with PEGSIL and coal in the ZNeck, ZUp, and ZDown regions relative to 10 μm, normalised to 1000 ZNeck;

FIG. 8 shows the CDF averages for water and polyhalite at 33 LPM in the ZNeck, ZUp, and ZDown regions;

FIG. 9 shows the CDF averages for water doped with PEGSIL and polyhalite at 33 LPM in the ZNeck, ZUp, and ZDown regions;

FIG. 10 shows the scrubbing efficiency of the system with water and polyhalite for the various particulate matter fractions and at the various flow rates;

FIG. 11 shows the scrubbing efficiency of the system with water doped with PEGSIL and polyhalite for the various particulate matter fractions and at the various flow rates;

FIG. 12 shows the particle diameter cumulative distribution function (“CDF”) for the high silica content particulate matter of experiment 5 in the <75 μm particle size range; and

FIG. 13 shows the performance of various tests performed in experiment 5 in terms of the beta values obtained for PM4, PM2.5, PM1, and PM0.5 bins respectively.

### DESCRIPTION OF THE INVENTION

The present invention will now be described more fully hereinafter with reference to the accompanying figures, in which some of the non-limiting embodiments of the invention are shown.

The invention as described hereinafter should not be construed to be limited to the specific embodiments disclosed, with slight modifications and other embodiments intended to be included within the scope of the invention.

Although specific terms are employed herein, they are used in a generic and descriptive sense only and not for purposes of limitation.

As used herein, throughout this specification and in the claims which follow, the singular forms “a”, “an” and “the” include the plural form, unless the context clearly indicates otherwise.

The terminology and phraseology used herein is for the purpose of description and should not be regarded as limiting. The use of the terms “comprising”, “containing”, “having”, “including”, and variations thereof used herein, are meant to encompass the items listed thereafter, and equivalents thereof as well as additional items.

As used in this specification, the term “particulate matter” should be understood to a mixture of solid particles and liquid droplets suspended in air and in particular, in this context, suspended in a waste gas stream.

As used in this specification, the terms “PM10”, “PM4”, “PM2.5”, “PM1”, and “PM0.5” should be understood to mean particulate matter having a nominal aerodynamic diameter of equal to or less than 10 micrometer (μm), equal to or less than 4 μm, equal to or less than 2.5 μm, equal to or less than 1 μm, and equal to or less than 0.5 μm respectively.

As used in this specification, the term “wet scrubber” should be understood to mean an air pollution control device that removes particulate matter and/or acid gases from waste gas streams. The pollutants are removed primarily through the impaction, diffusion, interception and/or absorption of the pollutant onto droplets of liquid. The liquid containing the pollutant is then generally collected for further treatment and/or disposal. Unless the context clearly indicates otherwise, as used herein the term “wet scrubbing” should be understood to a process for removing particulate matter and acid gases from a waste gas stream utilising a wet scrubber.

As used in this specification, the term “scrubbing liquid” should be understood to mean a liquid that is used in a wet scrubber or wet scrubbing process, and that interacts with particulate matter and/or acid gases in the waste stream. The scrubbing liquid may include one or more additives to improve the efficiency of the wet scrubbing system.

As used in this specification, the term “water soluble polymer” should be understood to mean a polymer that dissolves, disperses, or swells in water including polymers comprising hydroxyl groups, for example an ethylene oxide type polymer or a polyvinyl alcohol polymer.

As used in this specification, the term “beta value” should be understood to mean a value for a particular scrubbing system defined as the number of particles exiting the system for every 100 particles entering the system. For example, in a system where 15 particles exit the system for every 100 particles entering the system, the beta value would be 6.67. Alternatively, the efficiency of the same system could also be reported as 85%.

The present invention provides for a process of removing particulate matter from a waste gas stream, wherein the process utilises a scrubbing liquid that comprises a treatment composition. The invention further relates to a scrubbing liquid composition as such.

The inventors have surprisingly found that a scrubbing liquid including a treatment composition comprising a water soluble polymer based composition including a cationic silicate component improves the particulate matter removal efficiency of the scrubbing liquid and therefore the overall process. These treatment compositions have shown surprising and unexpected results in the removal of particulate matter from waste gas streams, or as an additive to a scrubbing liquid used in a process for the removal of particulate material for a waste gas stream.

The treatment composition can be dissolved in the scrubbing liquid to form a solution of the treatment composition in the scrubbing liquid at a concentration of about 0.01% and more. The treatment composition can, for example, be dissolved in water to form a solution of the treatment composition in water at a concentration of about 0.01% w/w to about 10% w/w relative to the scrubbing liquid. Other examples of the treatment composition in a scrubbing liquid would depend on the waste gas stream, the source of the particulate matter, and the standard operating parameters of the particular process. Such further examples could be defined by routine experimentation by those skilled in the art having the benefit of the teachings in the present disclosure.

The treatment composition may further comprise a second cationic component (in addition to the cationic silicate component) referred to herein as a cationic additive component, dissolved in and stabilised by the cationic silicate-polymer combination. The second cationic component, or cationic additive component may, for example, be a metal salt of metal oxide, such as zinc oxide, or cationic nanopowders, such as reduced graphene oxide.

The salt of the cationic additive component may be a salt of a compound selected from a group of compound classes including thiazoles, dithiocarbamates, dithiophosphates, sulfenamides, thiuram sulfides, xanthates, guanidines, aldehyde amines, or combinations thereof.

The polymer in the treatment composition is a water soluble polymer, for example an ethylene oxide type polymer, a polyvinyl alcohol polymer, or any other polymer comprising hydroxyl groups.

The water soluble polymer based treatment composition may be prepared as set out below. A suitable cationic silicate component solution is synthesized by dissolving silica powder in a basic solution, for example sodium hydroxide or potassium hydroxide. The resultant cationic silicate component may be added to a water soluble polymer, for example an ethylene oxide polymer including polyethylene glycol, and dried to produce a stable ionic solution or ionic liquid of the particular cationic silicate component.

The particular combination of the cation silicate component and the polymer, for example polyethylene glycol, as a replacement for the aqueous environment, allows for a suitably stable ionic solution. This has the implication of allowing it greater reaction capability and potential as a reactive solvent media and stabiliser for further cationic additive components that may be desirable in the final treatment composition.

It is envisaged that these cationic silicate solutions and the resultant cationic-silicate polymer combinations or complexes can be prepared by reacting different ratios of the selected cation to silica, thereby to modify the surface chemistry and the ionic nature of the solution and the resultant treatment compositions. In one embodiment of the invention, a stoichiometric ratio of cation to silica may be used. Alternatively, this ratio may be varied depending on the requirements of the particular system, and the particulate matter to be removed from a waste gas stream.

The cationic silicate component may be prepared in water, or in a suitable azeotrope of water and alcohol, preferably water and isopropyl alcohol.

In one embodiment of the invention the composition may further comprise, as a cationic additive component, the salt of a compound dissolved in the cationic silicate component and polymer carrier. The cationic additive complex may be prepared in a caustic aqueous solution, for example a solution of sodium hydroxide or potassium hydroxide. The cationic additive complex may be prepared by dissolving sodium hydroxide or potassium hydroxide in water before reaction with the compound.

The cationic additive complex may also be prepared in a suitable azeotrope of water and alcohol. In a preferred method of the present invention, the cationic additive complex is prepared in a water isopropyl alcohol azeotrope mixture.

The cationic additive may be based on the salt of a compound to be selected from a group of compound classes including thiazoles, dithiocarbamates, dithiophosphates, sulfenamides, thiuram sulfides, xanthates, guanidines, aldehyde amines, or combinations thereof.

In one embodiment, the compound for the cationic additive is a compound selected from a group of compound classes including thiazoles, dithiocarbamates, dithiophosphates, thiuram sulphides, or combinations thereof. Preferably, the salt is a sodium or potassium salt of 2-mercaptobezothiazole (MBT), zinc dibenzyldithiocarbamate (ZBEC), zinc dialkyldithiophosphate (ZBOP), tetrabenzyl thiuramdisulfide (TBzTD), Di-isopropyl xanthogen disulphide (DIXD) or polysulfide (AS100), or combinations thereof.

The cationic additive described above, or any other suitable ionic material such as metal salts, metal oxides, or nanopowders, is added to the cationic silicate solution to prepare a reaction mixture to which the water based polymer is added. The resultant reaction mixture is then dried to remove the solution medium, in particular to remove any water from the system. In one embodiment, the mixture may be dried under vacuum, for example at 100 mBar or less, to remove the solution medium. The resultant composition is a non-aqueous composition which is based on the water soluble polymer, for example polyethylene glycol.

The cationic additive component and the cationic silicate component may comprise about 50% of the total mass of the polymer based composition, with the water based polymer component making up the rest of the scrubbing liquid treatment composition.

It is envisaged that the scrubbing liquid treatment composition will find application in any wet scrubber apparatus including a spray tower, cyclonic spray tower, dynamic scrubber, tray towers, venturi scrubber, orifice scrubber, or any combination of the principles underlying these devices. In addition, interaction of the scrubbing liquid and the waste gas stream, including the particulate matter could take on several configurations. The systems could be adapted for interaction in a direction counter to the waste gas stream, in the same direction as the waste gas stream, or perpendicular to the waste gas stream. In the examples which follow the interaction was substantially in the same direction as the waste gas stream.

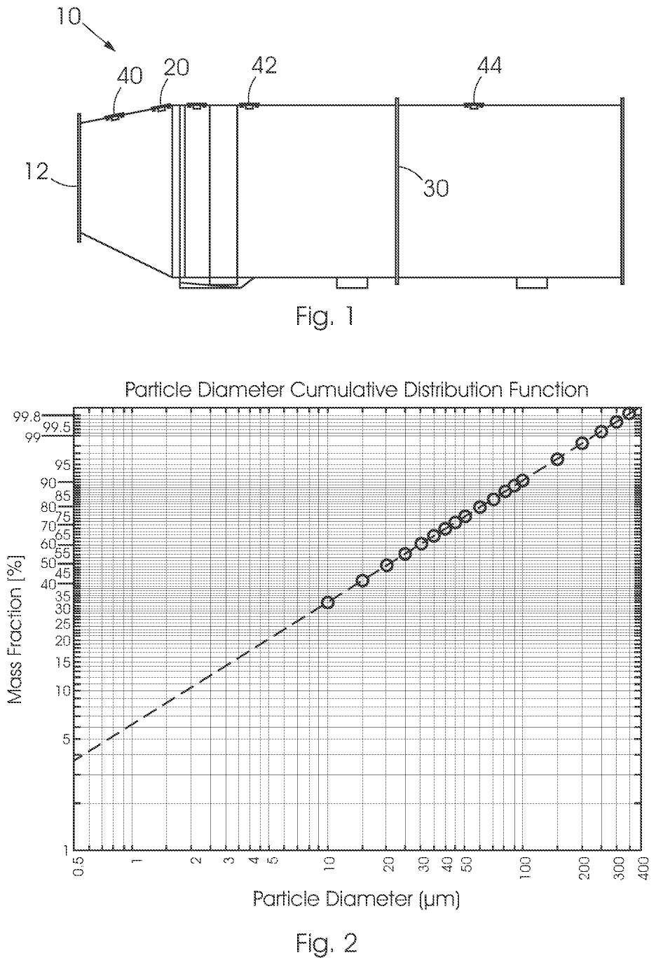

The wet scrubber configuration used in the examples described below is shown in FIG. 1. Referring to FIG. 1, the waste gas stream enters the wet scrubber 10 at entry point 12. Scrubbing liquid feed is provided through port 20, while a particulate matter filter screen 30 is provided downstream of the entry point 12 and the scrubbing liquid port 20. Particulate matter sensors 40, 42, and 44 are provided at various points in the system. Sensor 40 (hereinafter “ZNeck”) is located after entry point 12 but before port 20 in the area generally referred to as the neck of the system; sensor 42 (hereinafter “ZUp”) is located upstream of the screen 30; and sensor 44 (hereinafter “ZDown”) is located downstream of the screen 30.

The invention will now be described in more detail with reference to the following, non-limiting, examples and experimental results.

### Example Experiment 1: Preparation of sodium silicate/polyethylene glycol Complex Scrubbing Liquid Treatment Composition

In a suitable vessel 10 g of NaOH was added into 40 ml of water. To this solution, 7.5 g of silica powder was added while stirring. The solution was heated to 60° C. and the dissolution was seen to be rapid (the reaction is exothermic so not much heating is required). The solution was stirred for 5 minutes at 60° C. This solution is clear once the reaction of NaOH and SiO₂ is completed.

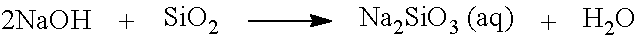

The sodium silicate solution can also be prepared in a suitable azeotrope, for example a water and isopropyl alcohol mixture.

15 g of polyethylene glycol was added to this solution where the amount of PEG is normally the same mass as the silicate content. The solution was stirred for 5 minutes at 60° C. until all the PEG is dissolved in the solution. The solution was dried at 105° C., at less than 100 mBar resulting in an amber clear sodium silicate-polyethylene glycol composition.

In the examples which follow, the above described sodium silicate-polyethylene glycol composition is referred to as “PEGSIL”.

### Example Experiment 2 (Control): Coal Particulate Matter Control, Water Only

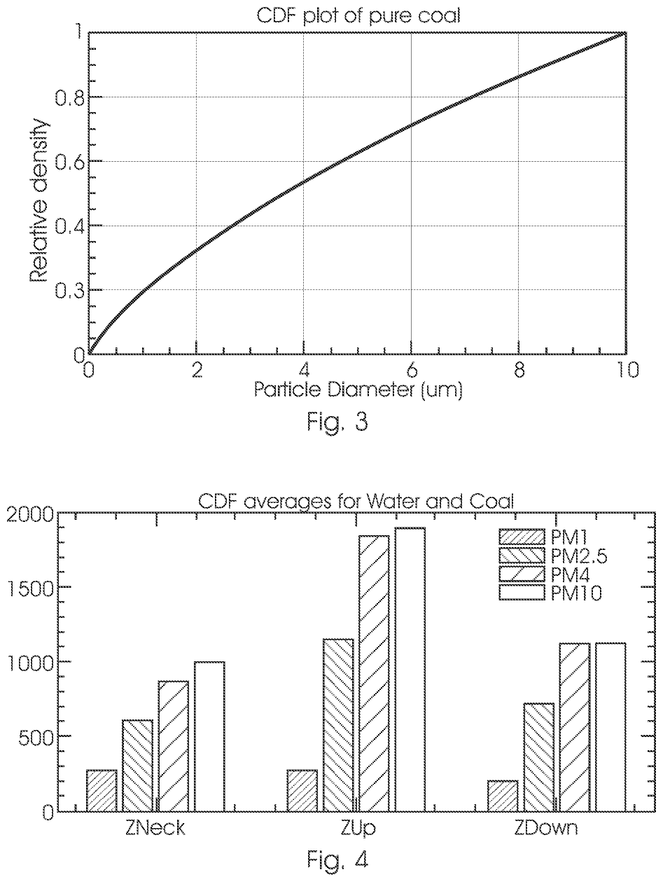

In this control experiment water was used as the scrubbing liquid. The waste gas stream included graded coal particulate matter having particle a diameter cumulative distribution function (“CDF”) as shown in FIG. 2. The coal particulate matter distribution is given as a CDF, and for the region particular to the Sensirion sensors (0.5 μm to 10 μm) the CDF is shown in FIG. 3. Sensirion particle sensors were positioned at positions ZNeck, ZUp, and ZDown as described above.

In terms of the mass flow of coal entering the system, the total removal of each system is determined using the known mass distribution of the coal and correcting for the relative counts as measured in the downstream sensors. The coal CDF for PM4 was about 15% if the total mass of the coal particulate matter entering the scrubbing system.

Standard water flow rates were 15 lpm to 33 lpm and air flow was 30 m·s⁻¹.

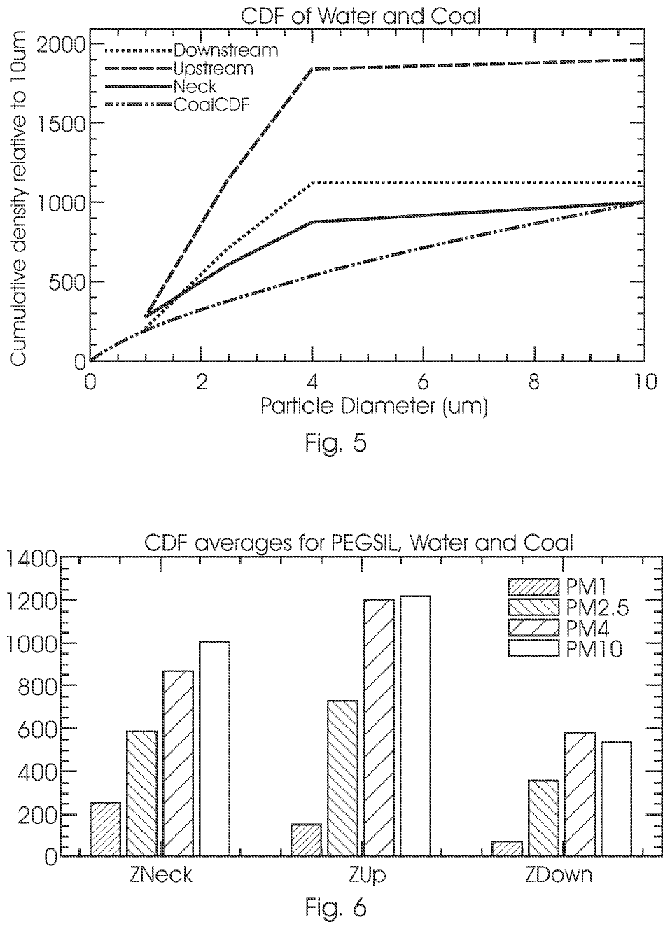

The results obtained for the removal of coal particulates from the waste gas stream utilising water as the scrubbing liquid is shown in FIGS. 4 and 5. As can be seen from these figures, it appears that there is an increase in the PM10, PM4, PM2.5 and PM 1 fractions when the ZNeck values are compared to ZUp, and even ZDown which is located downstream of the filter screen. Without wishing to be bound by any particular theory, it is speculated that this is as a result of collisions between coal particles themselves, and coal particles and water droplets, resulting in higher number of particulates in these size ranges.

Total coal leaving the scrubbing system is about 30% of the total coal entering the system, yielding a beta value of 3.33 (efficiency 70%) for the coal particles of this size range.

### Example Experiment 3: Coal Particulate Matter Control, PEGSIL Doped Water

In this experiment the scrubbing liquid was water with PEGSIL as the treatment composition at a mass dosage of 0.1% PEGSIL into the water system. The waste gas stream included the same graded coal particulate matter described in comparative experiment 1. Sensirion particle sensors were positioned at positions ZNeck, ZUp, and ZDown as described above.

In terms of the mass flow of coal entering the system, the total removal of each system is determined using the known mass distribution of the coal and correcting for the relative counts as measured in the downstream sensors. The coal CDF for PM4 was about 15% of the total mass of the coal particulate matter entering the scrubbing system.

Standard scrubbing liquid flow rates were 15 lpm to 33 lpm and air flow was 21 m·s⁻¹, as measured by anemometer directly upstream of the intake fan. Air flow was kept normal to the system as it determines the actual capacity and intake of particulate matter.

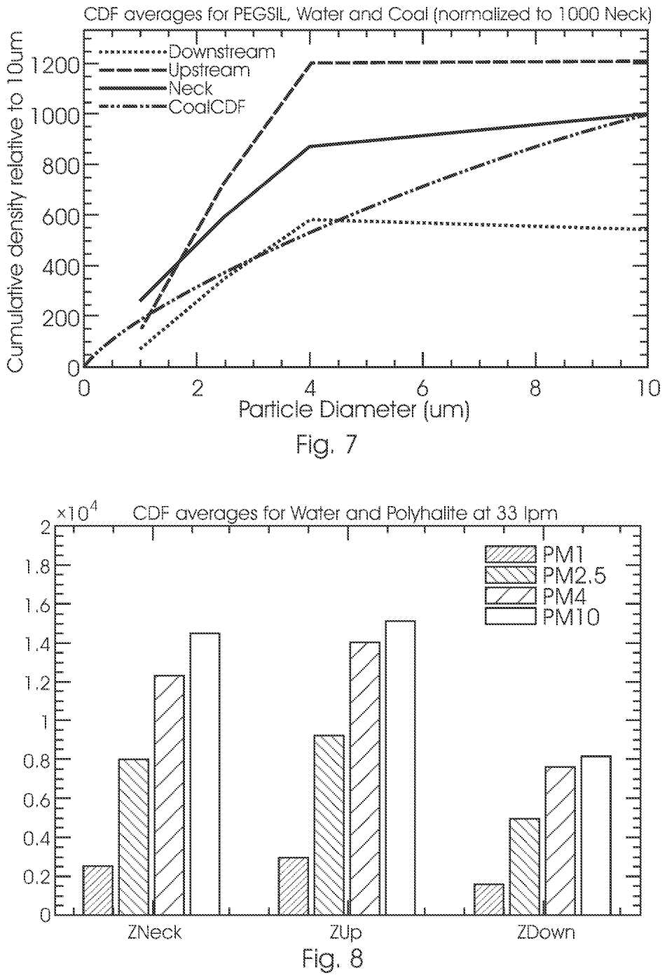

The results obtained for the removal of coal particulates from the waste gas stream utilising water as the scrubbing liquid is shown in FIGS. 6 and 7.

In experiment 1 (FIG. 4) the particulate screen eliminated about 39% of the PM4 particulates (i.e. particles of 4 μm and less). As can be seen from FIGS. 6 and 7, the system with the treatment composition doped scrubbing liquid reduced the PM4 particulate counts before the screen by about 35% (comparison of ZUp PM4 values from FIG. 4 and FIG. 5). Without thereby wishing to be bound by any particular theory, it is believed that this result is obtained as a result of superior wetting, and gravity thus removing the coal particulate matter from the gas stream. Accordingly, it can be seen that scrubbing liquid doped with a PEGSIL treatment composition without a particulate screen is as effective as the particulate screen in the comparative experiment, which mirrors a standard water scrubbing coal operation. Further, scrubbing liquid doped with a PEGSIL treatment composition reduces the particulate matter counts after the screen by about 48.5% compared to the comparative experiment, which is likely as a result of further interaction and wetting on the screen support. The scrubbing liquid doped with a PEGSIL treatment composition reduced the total particulate matter counts by 50% when compared to the water scrubbing system.

Total coal leaving the scrubbing system is about 15% of the total coal entering the system, yielding a beta value of 6.66 (efficiency 85%).

### Example Experiment 4: Polyhalite Scrubbing

In this series of experiments the scrubbing performance of water was compared to the use of water doped with 0.1% w/w PEGSIL as the scrubbing liquid. The waste gas stream included polyhalite, which is a mineral comprising hydrated sulfate of potassium, calcium and magnesium with the formula, K₂Ca₂Mg(SO₄)₄·2H₂O.

Experiments were conducted at 15 litres per minute (“LPM”), 22 LPM and 33 LPM. The mass counts of the particulate matter for the different particle size fragments where determined at ZNeck, ZUp, and ZDown. A determination of the beta values and efficiency Eta was then made.

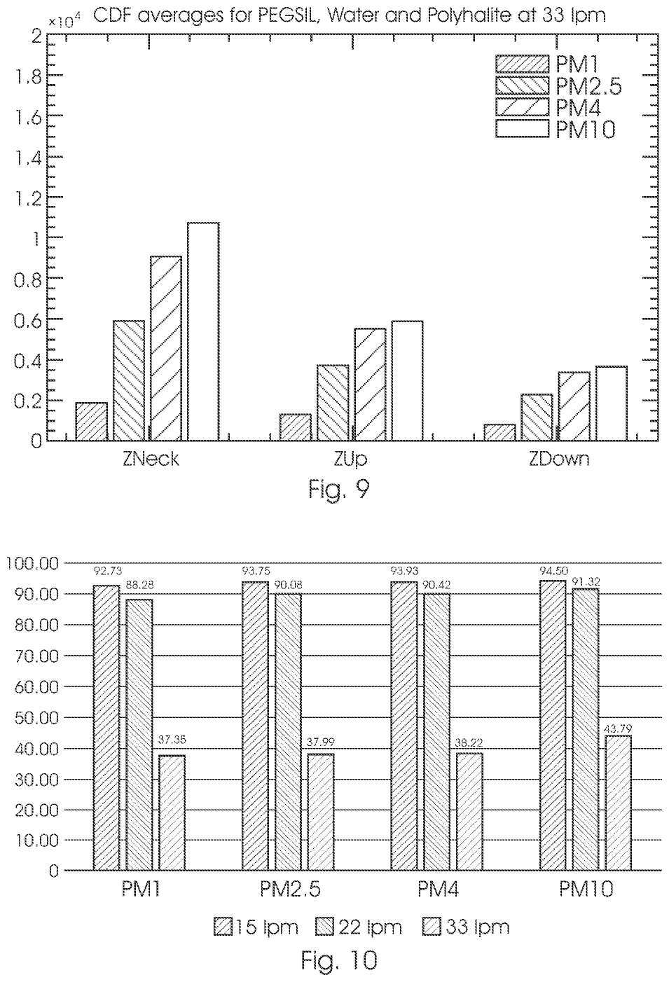

Representative graphs of the measurements made for the water and PEGSIL doped systems at 33 LPM are shown in FIGS. 8 and 9 respectively.

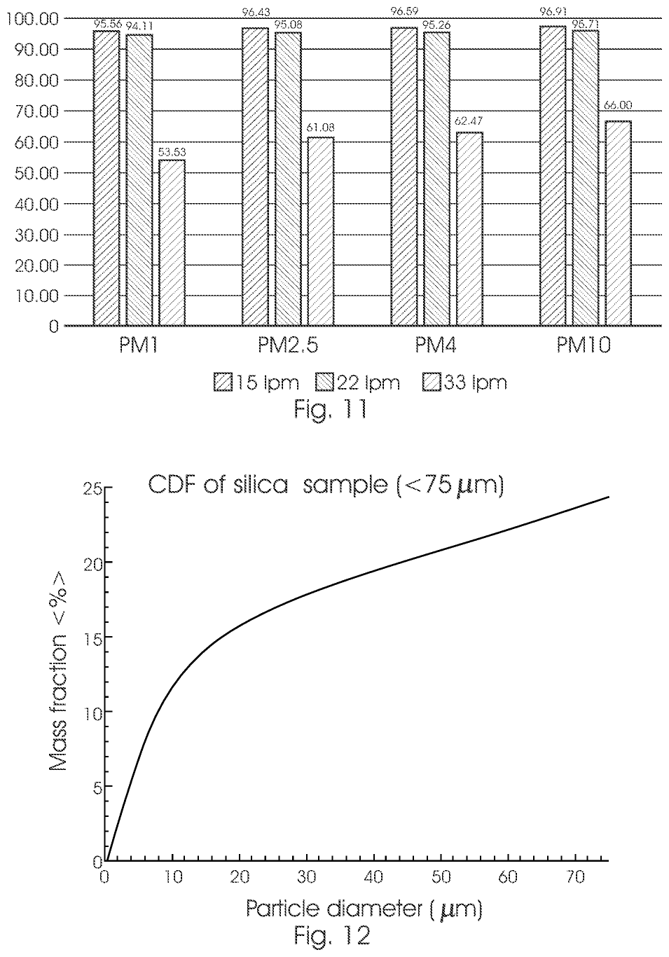

The results obtained and the efficiencies of the water and PEGSIL doped scrubbing systems are summarised in FIGS. 10 and 11. As can be seen from these figures, the system utilizing water doped with a PEGSIL treatment composition at 0.1% w/w as the scrubbing liquid significantly outperformed a standard water scrubbing system.

The efficiency of each system is represented by the beta value in Table 1 below. It is clear from the beta values shown in Table 1 that the PEGSIL doped system provides a significant efficiency improvement over water alone at each flow rate tested and for each particulate matter fraction. The implication of this results is that the use of a PEGSIL doped scrubbing system can potentially allow for a significant reduction in the use of water whilst maintaining particulate matter control, or can provide more efficient particulate matter control at the same flow rate of the standard scrubbing system.

TABLE 1
beta values for different particulate matter
fractions tested at 15 LPM, 22 LPM, and 33 LPM
for water and PEGSIL doped water, 0.1% w/w.

| Beta β | PM 1.0 | PM 2.5 | PM 4.0 | PM 10 |
|---|---|---|---|---|
| water 15 lpm | 13.76 | 16.00 | 16.47 | 18.18 |
| PEGSIL 15 lpm | 22.50 | 27.99 | 29.30 | 32.38 |
| water 22 lpm | 8.53 | 10.08 | 10.44 | 11.52 |
| PEGSIL 22 lpm | 16.98 | 20.33 | 21.10 | 23.31 |
| water 33 lpm | 1.60 | 1.61 | 1.62 | 1.78 |
| PEGSIL 33 lpm | 2.15 | 2.57 | 2.66 | 2.94 |

### Example Experiment 5: High Silica Content Particulate Matter Scrubbing, PEGSIL Doped Water

In this experiment the scrubbing liquid was again water with PEGSIL as the treatment composition at a dosage of 0.1% w/w PEGSIL. The efficiency of the PEGSIL doped scrubbing system for was compared to scrubbing with water only. The waste gas stream included high silica content particulate matter obtained from a South African gold mining operation.

The particle size distribution of the high silica content particulate matter is shown in FIG. 12. The region of importance for the wet scrubber is the particulate matter that can be airborne, which is typically matter of less than 75 μm in radius, which is typically referred to as the “float” region. As can be seen from FIG. 12 (CDF of silica particulate matter in the float region), about 11.5% of the particulate matter in this sample was in the toxic respirable range as expressed to the total silica.

The high silica content particulate matter was introduced as described before, and the system was allowed to reach steady state. In these experiments, different times of flushing with clean water as a scrubbing liquid were utilized to investigate the latent PEGSIL impact on the mesh of the scrubber. Table 2 below shows the beta values for tests 1 to 6 which were performed in this set of experiments.

TABLE 2
beta values for high silica content particulate matter with water (test 3),
PEGSIL doped water 0.1% w/w (test 4), and water flushing (tests 5 and 6)

| Test | Beta PM0.5 | Beta PM1 | Beta PM2.5 | Beta PM4 |
|---|---|---|---|---|
| Test 1: Water, no silica, | 1.31537 | 1.31504 | 1.31148 | 1.31128 |
| no PEGSIL | | | | |
| Test 2: PEGSIL 0.1% | 176.385 | 1689.9 | 2491.94 | 1556.19 |
| and silica (short run) | | | | |
| Test 3: Water and | 192.545 | 1324.32 | 1654.69 | 1256.29 |
| silica, no PEGSIL (mesh | | | | |
| not cleaned) | | | | |
| Test 4 PEGSIL 0.1% and | 528.64 | 2702.78 | 3136.06 | 2603.91 |
| silica | | | | |
| Test 5 Water and silica, | 123.222 | 415.937 | 451.538 | 406.821 |
| no PEGSIL | | | | |
| Test 6 Water and silica, | 48.6174 | 155.52 | 167.869 | 152.318 |
| no PEGSIL (final-clean) | | | | |

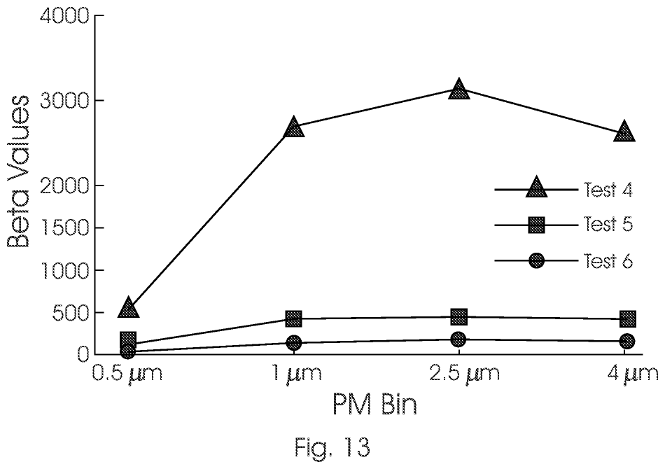

As can be seen from the results summarised in Table 2, at full steady state saturation (test 4) the beta values when using PEGSIL doped water (0.1% w/w) were far higher than the beta values obtained when using water as the scrubbing liquid. Test 5 shows how the scrubbing performance starts decreasing as PEGSIL is flushed out of the system, while Test 6 shows the final performance of the water system alone with all PEGSIL flushed from the mesh screen and no longer present in the system. The results of Test 4, Test 5 and Test 6 are summarised in FIG. 13 in which Test 6 shows the baseline for water, while Test 4 shows the optimal operating value for PEGSIL doped scrubbing of high silica content particulate matter.

This above description of some of the illustrative embodiments of the invention is to indicate how the invention can be made and carried out. Those of ordinary skill in the art will know that various details may be modified thereby arriving at further embodiments, but that many of these embodiments will remain within the scope of the invention.

1. A process for the removal of particulate matter from a gas stream, the process comprising:
a) providing a waste gas stream containing particulate matter, and
b) treating the waste gas stream with a scrubbing liquid to produce a treated gas stream having a particulate matter concentration that is less than a particulate matter concentration of the waste gas stream,
wherein the scrubbing liquid comprises a treatment composition,
wherein the treatment composition is a polymer based solution comprising a cationic silicate component, and wherein the polymer is a water soluble polymer.

2. The process according to claim 1, wherein the scrubbing liquid is a solution of the treatment composition in water.

3. The process according to claim 2, wherein the scrubbing liquid comprises about 0.01 to about 10% w/w of the treatment composition.

4. The process according to claim 1, wherein the scrubbing liquid comprises about 90 to about 100% w/w of the treatment composition.

5. The process according to claim 1, wherein the process is a wet scrubbing process including a wet scrubber device, and wherein the wet scrubber device is a device selected from the group consisting of a spray tower, a cyclonic spray tower, a dynamic scrubber, a tray tower, a venturi scrubber, and an orifice scrubber.

6. The process according to claim 1, wherein the waste gas stream has a PM10 concentration of about 5% to about 30% w/w based on the total-particulate matter content in the waste gas stream.

7. The process according to claim 6, wherein removal efficiency for a PM10 fraction is improved by 10% or more compared to removal efficiency for a process utilizing the same process parameters but excluding the treatment composition from the scrubbing liquid.

8. The process according to claim 6, wherein removal efficiency for a PM10 fraction is improved by 15% or more, 20% or more, or 30% or more compared to removal efficiency for a process utilizing the same process parameters but excluding the treatment composition from the scrubbing liquid.

9. The process according to claim 1, wherein the waste gas stream has a PM4 concentration of about 5% to about 30% w/w based on the total-particulate matter content in the waste gas stream.

10. The process according to claim 9, wherein removal efficiency for a PM4 fraction is improved by 10% or more compared to removal efficiency for a process utilizing the same process parameters but excluding the treatment composition from the scrubbing liquid.

11. The process according to claim 9, wherein removal efficiency for a PM4 fraction is improved by 15% or more, 20% or more, or 30% or more compared to removal efficiency for a process utilizing the same process parameters but excluding the treatment composition from the scrubbing liquid.

12. The process according to claim 1, wherein the waste gas stream originates from a mining operation, a grinding operation, general dust control, or an incineration or boiling operation.

13. The process according to claim 1, wherein the scrubbing liquid is directed counter to the waste gas stream, in a same direction as the waste gas stream, or perpendicular to the waste gas stream.

14. A treatment composition to improve particulate matter removal efficiency of a wet scrubbing process, the treatment composition comprising:
a polymer based solution of a cationic silicate component, and wherein the polymer is a water soluble polymer.

15. The treatment composition according to claim 14, further comprising a cationic additive component.

16. The treatment composition according to claim 15, wherein the cationic additive component is a salt of a compound selected from a group of compound classes comprising thiazoles, dithiocarbamates, dithiophosphates, sulfenamides, thiuram sulfides, xanthates, guanidines, and aldehyde amines.

17. The treatment composition according to claim 15, wherein the cationic additive component is a salt of a compound selected from a group of compound classes comprising thiazoles, dithiocarbamates, dithiophosphates, thiuram sulphides, or combinations thereof.

18. The treatment composition according to claim 15, wherein the cationic additive component is a salt of 2-mercaptobezothiazole (MBT), zinc dibenzyldithiocarbamate (ZBEC), zinc dialkyldithiophosphate (ZBOP), tetrabenzyl thiuramdisulfide (TBzTD), Di-isopropyl xanthogen disulphide (DIXD) or polysulfide (AS100), or combinations thereof.

19. The treatment composition according to claim 16, wherein the salt is a sodium or potassium salt.

20. The treatment composition according to claim 14, wherein a cation of the cationic silicate component is a sodium or potassium cation.

21. The treatment composition according to claim 14, wherein the water soluble polymer is an ethylene oxide polymer or polyvinyl alcohol polymer.

22. The treatment composition according to claim 21, wherein the water soluble polymer is polyethylene glycol.

23. The treatment composition according to claim 14, wherein the water soluble polymer has a molecular weight of between 300 g/mol and 10,000,000 g/mol, optionally between 500 and 20,000 g/mol, optionally between about 1,000 and 10,000 g/mol.

24. A scrubbing liquid suitable for use in a wet scrubbing method, the scrubbing liquid comprising a solution of a treatment composition in water at a concentration of about 0.01 to about 10% w/w of the scrubbing liquid, wherein the treatment composition comprises a polymer based solution of a cationic silicate component, and wherein the polymer is a water soluble polymer.
